(19) United States
(12) Patent Application Publication
(10) Pub. No.: US 2026/0097447 A1
(43) Pub. Date: Apr. 9, 2026

(54) DEVICE FOR DETERMINING THE FOCAL POSITION OF A PROCESSING LASER BEAM

(71) Applicant: TRUMPF LASER SE, Schramberg (DE)

(72) Inventors: Matthias HARTMANN, Schramberg (DE); Jan-Patrick HERMANI, Markgröningen (DE); Martin STAMBKE, Aichhalden (DE); Sebastian NEUDECK, Schramberg (DE); Julian HELLSTERN, Rottweil (DE)

(21) Appl. No.: 19/415,829

(22) Filed: Dec. 11, 2025

Related U.S. Application Data
(63) Continuation of application No. PCT/EP2024/065352, filed on Jun. 4, 2024.

(30) Foreign Application Priority Data
Jun. 16, 2023 (DE) 10 2023 115 764.7

(51) Int. Cl. B23K 26/046; B23K 26/03

(52) U.S. Cl. CPC B23K 26/046; B23K 26/032

(57) ABSTRACT

A device for determining a focal position of a processing laser beam in relation to a surface of a workpiece, including a measurement light source to emit measurement light at at least two different measurement wavelengths, a processing head to focus the measurement light onto the workpiece, and a beam guide to guide the measurement light to the processing head. The device includes at least one optical element with chromatic aberration, which is passed through by the measurement light and arranged in the processing head and a detector configured to capture an intensity of the measurement light reflected by the surface. The device includes an evaluator configured to determine the focal position of the processing laser beam in relation to the surface using the intensity captured by the detector. The beam guide is configured for jointly beam-guiding the processing laser beam and the measurement light to the processing head.

### CROSS REFERENCE TO RELATED APPLICATIONS

This application is a continuation of International Application No. PCT/EP2024/065352 (published as WO 2024/256223 A1), filed on Jun. 4, 2024, and claims benefit to German Patent Application No. DE 10 2023 115 764.7, filed on Jun. 16, 2023. The aforementioned applications are hereby incorporated by reference herein.

### FIELD

The present invention relates to a device for determining the focal position of a processing laser beam in relation to a surface of a workpiece.

### BACKGROUND

For the purposes of this application, a workpiece is understood to be any object in relation to the surface of which the focal position is to be determined. The workpiece can be an object intended for processing with the processing laser beam. However, the workpiece can also be an object that is not intended for processing with the processing laser beam and the surface of which forms a reference for determining the focal position of the processing laser beam in relation to this reference.

Laser machining processes, in particular welding processes with fixed optics, robot-guided remote welding processes with scanner optics, laser cutting and various ultrashort pulse applications require an increasing degree of sensor monitoring in order to meet rising demands for high and consistent machining quality. A fundamental distinction can be made between on-line and off-line sensor systems as well as the on-axis and off-axis arrangement of a sensor system.

Depending on the laser application, there are various characteristics that can be detected by means of sensors in order to evaluate the processing result (such as welding depth, thermal field at the processing zone, position of the joining partners, etc.) and, depending on the laser application, various laser processing parameters to be taken into consideration (such as the beam geometry, wavelength, etc.) or to be controlled by the use of sensor systems (such as the laser power, feed rate, positioning of the processing laser beam, etc.).

The processing quality and process stability of a wide range of laser applications depends on the process control with a focal position that is set in a targeted manner and as constant as possible and which can be captured by means of a sensor system. In this context, the focal position represents the distance between the focus of the processing laser and the surface of the target or workpiece to be processed, measured along the optical axis of the processing optics integrated in a processing head. As an example, in order to avoid spatter when laser welding steel materials, welding at a focal position of −2 mm is recommended. Here, the laser processing focus is moved 2 mm from the surface of the workpiece into the interior of the workpiece. This value is based on empirical experience.

In practice, it is customary to maintain an accuracy of ⅓ of the Rayleigh length of the processing laser beam when adjusting the focal position. This is particularly challenging to implement in cases of laser processing with small irradiation diameters of a few 10 μm (by way of example, 11 μm), small imaging ratios when using, for example, short focal length focusing optical units in the two-digit mm range (by way of example, 65 mm) and the associated short Rayleigh lengths of significantly less than 1 mm (by way of example, 0.14 mm). The focus adjustment is made even more difficult if the focal position or the distance between the workpiece surface and the processing optics changes during the laser process, for example in ablation processes using ultrashort pulse lasers, and thus the initially set focal position loses its validity over the duration of the process.

The applications emerging in the context of electromobility in particular require frequent and, above all, fast focal position determination, focal position monitoring or focal position tracking: For example, the stator of an electric motor contains a plurality of so-called hairpin pairs, wherein the position of the end faces to be welded varies due to manufacturing tolerances. The welding process is sensitive to deviations in the focal position so that it should be captured and corrected before laser processing each pair of hairpins. Another example is the welding of contacts on battery blocks or contacts on different planes of other electronic assemblies. In the production of fuel cells, it is also important to rotationally align the plane field of a laser scanner optical unit as precisely as possible with respect to a large workpiece (bipolar plate, 15 cm×30 cm by way of example) so that weld paths that extend over a long length are welded over the entire workpiece in the best possible manner with the intended focal position.

In practical applications, the focal position is also subject to fluctuations due to deviations in the shape and position of the workpiece (tolerances or fluctuations in the manufacturing process, tolerance of the workpiece clamping), inaccuracies in the actuators guiding the processing optics (such as absolute positioning accuracy of an industrial robot that guides the scanner optics) or chronological changes in the processing optics (thermal focus shift due to heating and associated distortion or change in the refractive index of the components of the processing optics).

There are various possibilities for determining the focal position, several of which are described below:

Focus bracketing: Multiple processing laser pulses are emitted one after the other onto a black anodized aluminum sheet, while between the individual laser pulses the distance between the processing optics and the aluminum sheet always varies with the same (known) step width and direction and the sheet is also displaced laterally in relation to the processing laser beam. Alternatively, the focal position can be changed by moving lenses or changing the focal length of a focusing mirror within the processing optics. The distance between the processing optics or processing head and the sheet is roughly selected at the beginning of the focus bracketing in such a manner that the processing optics pass through the focal position 0 approximately in the middle of the focus bracketing, at which the focus of the processing laser beam is located on the surface of the workpiece. With each laser pulse, the anodized layer of the aluminum is removed at the corresponding processing position, causing the processing position to stand out as a bright spot from the surrounding sheet. A subsequent measurement of the individual processing positions serves to ascertain the processing position with the smallest diameter. At this processing position, the processing took place close to or in the focal position 0.

WO 2020/143861 A1 describes a method and a device for the controlled laser processing of a workpiece by means of confocal distance measurement. Therein, an optical confocal distance measuring device with variable focal length measurement light optics is used, the focal length of which is varied over time in order to capture distance measurement data at different focal length values. Capturing the distance measurement data comprises capturing an intensity of the measurement light reflected back from the workpiece to be processed, and the distance is ascertained on the basis of a curve over time of the intensity of the measurement light reflected back from the workpiece to be processed. If the focus is on the surface of the workpiece, the intensity of the measurement light is maximized. The focal position can be inferred on the basis of the curve over time of the intensity of the measurement light reflected back.

DE 10 2019 004 337 A1 describes a beam analysis device for determining an axial focal position of a measurement beam decoupled from a laser beam. The device comprises a sub-beam imaging device which is designed to receive a first measurement beam and which comprises a first selection device for forming a first sub-beam from a first sub-aperture region of the first measurement beam. The device comprises a detector unit with a light-sensitive detector and an evaluation unit for processing signals from the detector unit. The first selection device is arranged off-center with respect to an optical axis intended for the emission of the first measurement beam and the sub-beam imaging device is designed to image the first sub-beam for generating a first beam spot on the detector unit. The evaluation unit is designed to determine the lateral position of the first beam spot. A change in the axial focal position of the measurement beam correlates with a change in the lateral position of the first beam spot.

DE 10 2018 211 166 A1 and WO 2020 007 984 A1 describe a method and a device for checking the focal position of a pulsed laser beam relative to a workpiece. The laser beam is focused at a plurality of positions along a trajectory on the workpiece and radiation is detected that is generated by an interaction of the pulsed laser beam at a respective position. On the basis of signal values that correspond to the detected radiation at a respective position, the focal position is checked at at least one of the positions. For this purpose, the signal value at the position is compared with a reference value formed from the signal values.

A further option for determining the focal position of a processing laser beam is a commercially available sensor system, also known as a CalibrationLine sensor. This sensor system essentially consists of a pinhole aperture with a photodiode mounted behind it. The sensor system is mounted away from the workpiece to be processed. In order to determine the focal position, the processing optics are placed over the pinhole aperture in such a way that it coincides with the assumed position of the laser focus. The pinhole aperture is then laterally scanned by deflecting the processing laser beam (for example, by means of scanner optics or fixed optics attached to a robot). Meanwhile, the intensity values measured at the photodiode are recorded. If the pattern is repeated at different distances between the laser optics and the pinhole aperture, a three-dimensional intensity map is created from which, among other things, the focal position of the processing laser beam can be calculated.

Another option is to cut a focusing comb: A utility program is used to cut multiple comb-shaped cuts into a component. In this regard, the focal position is varied from cut to cut and then the smallest kerf is ascertained by checking with a feeler gauge.

It is also made possible to determine the focal position indirectly using a distance sensor system that captures the distance between the workpiece and any reference point. The reference point can, for example, be the zero point of the measurement range of optical coherence tomography (OCT). In this case, however, a further step is required beforehand: The creation of a reference between the focal position of the processing laser and the reference point of the distance sensor system. This is achieved using a supplementary sensor system solution, for example the CalibrationLine sensor described above, by using it to first capture the focal position of the processing laser beam away from the workpiece to be processed. Additional reference features of the CalibrationLine sensor enable the distance sensor system, for example the OCT sensor system, to geometrically reference the coordinate system of the CalibrationLine sensor and thus the reference with respect to the focal position captured by the CalibrationLine sensor is also provided.

The known methods described above have in common that they carry out a focal position determination, which either individually or in combination:
is performed only with indirect reference to the workpiece, as the measurement cannot be performed on it (CalibrationLine sensor/focus bracketing);
is performed only with indirect reference to the focal position, as the focal position is reconstructed from a measured value that is not directly related to it (for example, OCT: measures a distance on the workpiece to a reference point determined for metrological reasons, which does not correspond to the focal position 0 and which must therefore be related (calibrated) to the focal position 0 using additional aids, such as the CalibrationLine sensor);
is too slow as measured in relation to fast process cycle times for a focus measurement at the start of each machining process (CalibrationLine sensor/focus bracketing);
is technically or economically difficult due to the need for processing on different planes subject to corresponding tolerances (CalibrationLine sensor/focus bracketing);
is associated with manual effort (focus bracketing);
does not capture all interferences in the optical path or beam path of the processing laser beam that affect the focal position (WO 2020/143861 A1 and DE 10 2019 004 337 A1);
is expensive if the corresponding sensor system is only to be used for the purpose of focal position measurement (OCT).

DE 10 2009 059 245 A1 describes a device for capturing and adjusting the focus of a laser beam during the laser processing of workpieces, comprising: an optical device for providing and focusing a laser beam emitted by a processing laser, which has a focusing element arranged in a processing head, at least a first and a second alignment light source which emit radiation of different wavelengths, an optical device for providing and focusing the radiation emitted by the alignment light sources onto the surface of the workpiece to be processed, an optical decoupling device for decoupling the radiation of the alignment light sources reflected back from the surface of the workpiece to be processed, which has a chromatic aberration, a detector for capturing the intensities of the reflected radiation of the alignment light sources, and an evaluation apparatus for determining the position of the focus of the laser beam of the processing laser in relation to the surface of the workpiece to be processed.

The basis for capturing the focal position described in DE 10 2009 059 245 A1 is the chromatic confocal principle, which utilizes the wavelength-dependent refractive index of electromagnetic radiation (primarily UV, VIS, NIR, IR) as it passes through optical elements and the resulting chromatic aberration. As such, the focus of broadband light emanating from a point light source, which is collimated using lenses and then refocused, undergoes a spectral spread after focusing: As the different wavelength components of the broadband light are focused on different positions along the optical axis, its focus appears elongated overall. If a target, such as a workpiece, is now placed within the focus area, predominantly light of the wavelength that is in focus enters and passes through the optics on the same path that it has already passed on its way through the optics to the target. If all the light reflected by the target is directed onto an aperture acting as a spatial filter, this mainly allows light of the wavelength, the focus of which is on the surface of the target, to pass through. This light is captured by a detector unit (often a spectrometer), wherein the spectral information allows a direct conclusion to be drawn as to the position of the target relative to any other wavelength of the measurement light.

### SUMMARY

In an embodiment, the present disclosure provides a device for determining a focal position of a processing laser beam in relation to a surface of a workpiece, comprising a measurement light source configured to emit measurement light at at least two different measurement wavelengths, a processing head configured to focus the measurement light onto the workpiece, and a beam guide configured to guide the measurement light to the processing head. The device comprises at least one optical element with chromatic aberration, which is passed through by the measurement light and is arranged in the processing head and a detector configured to capture an intensity of the measurement light reflected back by the surface of the workpiece. The device comprises an evaluator configured to determine the focal position of the processing laser beam in relation to the surface of the workpiece using the intensity captured by the detector. The beam guide is configured for jointly beam-guiding the processing laser beam and the measurement light to the processing head.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic representation of a device for determining the focal position of a processing laser beam, wherein the device comprises a beam guiding apparatus with an optical cable for guiding the processing laser beam and measurement light from a laser device to a processing head;

FIG. 2a illustrates a schematic representation analogous to FIG. 1, in which the laser device has a measurement light source with two laser diodes;

FIG. 2b illustrates a schematic representation analogous to FIG. 2a, in which the beam guiding apparatus is designed to guide the processing laser beam and the measurement light in free beam propagation;

FIG. 3 illustrates a schematic representation analogous to FIG. 2a, in which the laser device has a separating apparatus in the form of a double-clad fiber coupler in order to separate measurement light fed to the workpiece from measurement light reflected back from the workpiece;

FIG. 4 illustrates a schematic representation analogous to FIG. 1, in which the laser device has a measurement light source in the form of a broadband light source and a detector unit in the form of a spectrometer; and

FIG. 5 illustrates a schematic representation analogous to FIG. 1, in which the laser device has a tunable measurement light source and a separating apparatus in the form of a free beam circulator.

### DETAILED DESCRIPTION

In an embodiment, an improved device is provided for determining, in particular for monitoring and correcting, the focal position of a processing laser beam, which is based on the chromatic confocal principle.

The foregoing is achieved by a device in which the beam guiding apparatus is designed for jointly beam-guiding the processing laser beam and the measurement light to the processing head. The beam guiding apparatus is typically designed for coaxial beam guidance of the processing laser beam and the measurement light. The processing laser beam and the measurement light are typically guided coaxially onto the workpiece by processing optics in the processing head. The beam guiding apparatus also serves to guide the measurement light reflected back from the surface of the workpiece.

In contrast to what is described in DE 10 2009 059 245 A1, in the device described here the measurement light is not coupled into the beam path of the processing laser beam in the processing head, but in the beam path in front of the processing head, typically in a laser device (see below) which is arranged at a distance from the processing head. In this way, the common beam path of the processing laser beam and the measurement light is extended and/or they have the same beam path, which is why all optical elements that have an influence on the focal position of the processing laser beam are taken into account when determining the focal position with the aid of the measurement light. In this manner, it is made possible to correctly determine the focal position even in the event of a thermal focus shift, if the end cap has slipped in the connector of an optical cable or when changing an optical cable.

The device designed in this way is also robust and exhibits a direct reference with respect to the processing laser beam: In the device described here, the focal position is determined directly on the workpiece and not on a target that is used away from the workpiece for focus bracketing or not as with the CalibrationLine sensor described above, in which the focal position is also captured away from the workpiece to be processed.

The focal position determined with the aid of the device can be compared with a target focal position, i.e., the focal position can be monitored with the aid of the device. If the focal position determined using the device deviates from the target focal position, the focal position can be corrected. In particular, the distance between the processing optics and the surface of the workpiece can also be corrected in this case, if applicable.

In an embodiment, the measurement light source and preferably the detector unit are integrated in a laser device for providing the processing laser beam, which preferably has a processing laser source for emitting the processing laser beam, and the beam guiding apparatus is designed for jointly-guiding the processing laser beam and the measurement light from the laser device to the processing head. Typically, the detector unit and the measurement light source are arranged in a common sensor unit, which has an exit at which the measurement light emerges, wherein the output usually also forms the entry for the measurement light reflected back from the workpiece. On its way from the laser device to the processing head or processing optics, the measurement light follows the same path as the processing laser beam, i.e., the measurement light also moves through the same transport medium (free beam or optical cable, see below). In a fiber-guided sensor unit, the measurement light is preferably decoupled via a (common) output fiber, which can be designed as a single-mode or multi-mode fiber. The step for decoupling the measurement light is already anticipated in a free beam setup of the sensor unit, for example by early decoupling of the measurement light directly at the exit of the measurement light source.

In the embodiment described here, a chromatic confocal capture of the focal position is implemented, which is integrated into the combination of laser device, beam guiding apparatus (usually optical cable or free beam, for example in the case of USP laser applications) and processing head or processing optics. The processing optics of the processing head can be implemented as a rigid or scanning structure. The device designed in this way is compact, easy to integrate and highly economical in use, as the measurement light source and the detector unit are integrated into the laser device and do not have to be newly purchased for each existing processing optics or for each processing head. The device can also be assembled from standard parts, keeping manufacturing costs low. The determination of the focal position can furthermore be performed within a few milliseconds and can therefore be carried out before each weld, for example.

In an embodiment, the beam guiding apparatus has an optical cable for jointly beam-guiding the processing laser beam and the measurement light. In this case, one fiber end of the optical cable on the processing head typically serves as an exit aperture and as an entry aperture for the chromatic confocal focal position determination or for the sensor unit provided for this purpose. The optical cable acts as a spatial filter and primarily allows the reflection of that particular measurement wavelength of the measurement light, the focus of which is on the surface of the workpiece, to pass through. In the case described here, where the beam guiding apparatus has an optical cable, it is advantageous if the coupling into the optical cable is implemented with the smallest possible beam waist (taking into account the limiting angles of any existing exit fiber of the measurement light and the optical cable), as this allows for optimal coupling efficiency for optical cables with different core diameters (such as 50 μm to 400 μm).

In the simplest case, the chromatic confocal response of the overall system is available as an unfiltered intensity signal that is captured by the detector unit. For this reason, the sensor structure or the sensor unit is sensitive to any measurement light reflections that do not originate from the workpiece. As the transport medium in the form of the optical cable between the laser device and the processing optics in the processing head guides the measurement light both to the workpiece and from the workpiece back to the laser device or to the sensor unit contained therein, the useful signal (i.e., the measurement light component reflected by the workpiece and which can be evaluated) would be superimposed in an interfering manner by reflections arising in the transport medium. In the case of a fiber-guided processing laser beam or measurement light, for example, the reflections occur at the fiber entry and at the fiber exit (the refractive index transition between glass and air causes a back reflection of approx. 4 % at the vertical end face of the optical cable without an anti-reflective coating). Therefore, in particular when using standard optical cables or double-clad fibers or BrightLine Weld fibers, precautions must be taken to reduce the back reflections at the fiber entry and fiber exit. For this purpose, for example, end caps with an anti-reflective coating can be attached to the optical cable.

In an embodiment, the optical cable is designed as a hollow-core fiber or as a multi-clad fiber, in particular as a double-clad fiber. With a hollow-core fiber, the light is guided in a hollow core. Hollow-core optical cables therefore generally do not require an end cap or anti-reflective coating, as the light guided in the hollow core does not undergo a change in the refractive index when entering or exiting the fiber. A double-clad fiber has a light-guiding ring between the light-guiding core and the surrounding sheath. The ring can, for example, be used to guide the measurement light reflected back, while the core is used to guide the measurement light to the workpiece. Instead of a double-clad fiber, a multi-clad fiber can also be used, which is designed as a triple-clad fiber or a quad/clad fiber.

In a development, the detector unit is designed for separately capturing the intensity of the measurement light reflected back from the surface of the workpiece in a core, in a sheath and/or in a ring of the optical cable. The measurement light that is reflected from the workpiece and can be evaluated is also referred to below as the useful light. The separate capture of the intensity is also understood to mean the sole capture of the intensity of the measurement light reflected back from the surface of the workpiece in the core, sheath or ring of the optical cable.

When using an optical cable as a beam guiding apparatus, the core of the cable forms the entry aperture of the chromatic confocal measurement principle. Since both the sheath of all types of optical cables described above and the ring of a double-clad fiber or a BrightLine Weld optical cable represent a further entry face for the measurement light, are suitable for guiding the measurement light and have a large cross-section compared to the fiber core, a joint evaluation of the useful light component from the sheath of the optical cable or from the ring of the optical cable with the useful light component of the core of the optical cable increases the blurring of the measurement principle.

It is therefore made possible or advantageous to remove the useful light component guided in the sheath and in the ring of the optical cable before it enters the sensor device.

Appropriate precautions can be taken to separate the useful light component, which is guided in the sheath of the optical cable, such as in the form of etched sheath surfaces. In order to remove the measurement light component in the ring of the optical cable, an additional entry aperture can be provided in the sensor device. In this case, a separate, sole capture of the intensity of the useful light component reflected back in the core of the optical cable is performed in the detector unit.

The detector unit can also be designed for selectively capturing the intensity of the useful light component reflected back in the core, sheath or ring of the optical cable. If necessary, the detector unit can, in each case, have its own detector for capturing the useful light component reflected back in the core, in the sheath and, if applicable, in the ring of the optical cable. It is also made possible to capture only the useful light coming from the sheath and/or the ring of the optical cable without capturing the useful light coming from the core of the optical cable at all.

Alternatively, the detector unit can be designed for separately capturing the useful light coming from the sheath or from the ring of the optical cable, which is performed separately from capturing the useful light component in the core of the optical cable. This allows for a two-stage measuring process in which the evaluation of the useful light coming from the sheath and/or the ring is used for an inaccurate focal position determination with an enlarged measurement range and the sole evaluation of the useful light component coming from the core of the optical cable is used for the accurate focal position determination with a small measurement range.

Two or more measurement ranges of different sizes, in which the focal position is determined with different measuring accuracies, can be advantageous for determining the focal position for the following reason, among others: The processing optics in the processing head (fixed optics or scanner optics) focus both the processing laser beam and the measurement light via a corresponding focusing optical unit, for example in the form of a focusing lens. The processing optics generate the focal spread of the measurement light required for the sensor principle through chromatic aberration. Assuming otherwise constant conditions, the focal length of the processing optics of the processing head determines the degree of focal spread of the measurement light along the optical axis and thus ensures the adaptivity of the sensor system: As the focal length and depth of field of the processing laser beam decrease, the accuracy requirement with respect to determining the focal position increases. However, as the focal length decreases, the Rayleigh length of the measurement light also decreases, thus allowing for a higher-resolution focal position determination (with a smaller measurement range).

In an alternative further development, the beam guiding apparatus is designed for jointly beam-guiding the processing laser beam and the measurement light in free beam propagation. In this case, the processing laser beam and the measurement light are guided to the processing head through the air, which serves as the transport medium. Here, an entry aperture is provided in the laser device or in the sensor unit in order to carry out the chromatic confocal measurement. An exit fiber or an exit-side fiber end of the exit fiber of the sensor unit can serve as the exit aperture for the measurement light, which at the same time forms the entry aperture for the measurement light reflected back. In the event that the beam guidance in the sensor unit occurs entirely or partially in free beam propagation, an exit aperture can be provided as a separate component.

The choice of transport medium (optical cable or free beam) and the type of optical cable depends on the application. If the sensor unit is adapted to a disk, fiber or diode laser, it is usually an ordinary optical cable with a light-guiding core and sheath or a double-clad fiber or BrightLine Weld fiber, which is able to guide different components of light in the core and in the ring. In the case of an adaptation to an ultrashort pulse laser, it is typically a hollow-core optical cable or the free beam.

In an embodiment, the device has a coupling device for coupling the measurement light of the measurement light source into the beam path of the processing laser beam and for decoupling the measurement light reflected back from the surface of the workpiece from the beam path of the processing laser beam, wherein the coupling device is preferably arranged in the laser device. The coupling and decoupling of the measurement light typically takes place in the laser device before the joint coupling of the measurement light and the processing laser beam into the beam guiding apparatus. The coupling and decoupling of the measurement light is usually performed with a free beam. The coupling device for coupling and decoupling the measurement light can be designed in different ways, for example as a (optionally tightly toleranced) dichroic beam splitter, as an apertured mirror or as a scraper mirror. In this embodiment, the coupling device is typically arranged in a fixed position and simultaneously enables the workpiece to be processed with the processing laser beam and the focal position of the processing laser beam to be determined with the aid of the measurement light.

In an embodiment, the coupling device forms a beam switch, which can be arranged in the beam path of the processing laser beam for selective coupling of the processing laser beam or the measurement light into the beam guiding apparatus and can be removed from the beam path of the processing laser beam. In this case, determining the focal position of the processing laser beam is only possible before or after, but not simultaneously with the processing of the workpiece by the processing laser beam. The beam switch can also optionally provide a pilot laser beam to the beam guiding apparatus. In this case, in addition to providing the measurement light, the laser device or sensor unit is designed to provide a pilot laser beam in order to couple the visible pilot laser beam into the beam path of the processing laser beam instead of the measurement light.

In an embodiment, the device comprises a separating apparatus for separating the measurement light emitted by the measurement light source from the measurement light reflected back from the workpiece, wherein the separating apparatus is preferably arranged in a sensor unit of the laser device. As the measurement light emitted by the measurement light source and the measurement light reflected back from the surface of the workpiece and the processing laser beam are guided coaxially between the laser device and the workpiece, the individual beam components must be separated before or in the sensor unit in order to evaluate the useful signal. In order to make the useful signal of the entire optical cable cross-section available for evaluation even when using optical cables with a larger core diameter (such as 400 μm) in the beam guiding apparatus, it is advantageous to select the entry aperture of the sensor unit or the detection area of the detector unit ideally larger than the smallest possible exit face for the measurement light.

As described above, the sensor unit typically comprises the detector unit and the measurement light source and, if applicable, other components such as the evaluation apparatus and/or a control device for controlling the measurement light source. The sensor unit typically has an exit for decoupling the measurement light, which at the same time forms an entry for the measurement light reflected back from the workpiece. All measurement light is separated from the beam path of the processing laser beam by the coupling device described above, which also acts on the useful radiation coming from the workpiece.

In the simplest case, the measurement light in the sensor unit is guided in free beam propagation and the separating apparatus is designed as a non-polarizing 50:50 beam splitter.

However, such a beam splitter reduces both the intensity of the measurement light and the useful light in the form of the measurement light reflected back from the workpiece and thus reduces the efficiency of the sensor unit or the measurement.

In development of this embodiment, the separating apparatus is designed as a circulator in the form of a fiber circulator or a free beam circulator.

In the case of a sensor unit that is fully or partially fiber-guided, the separation of the emitted measurement light and the useful signal can be achieved by means of a fiber circulator. The fiber circulator can be connected to the measurement light source at a first port via a first fiber. A second fiber at a second port forms the exit face for the measurement light and the entry face for the useful signal and a third fiber at the third port is used for the emergence of the useful signal. As in this case the exit and entry faces of the measurement light or useful signal coincide directly, the sensor structure or the sensor unit is sensitive to back-reflected measurement light, which primarily occurs when the measurement light emerges at the second port (transition from glass to air). This can be countered by providing the exit or entry fiber, which is connected to the second port, with an end cap featuring an anti-reflective coating.

In the case of a sensor unit implemented partially or completely in the manner of a free beam, the separation of measurement light and useful signal is preferably implemented by means of a free beam circulator. A free beam circulator can, for example, have a Faraday rotator and other optical elements that separate the measurement light emitted to the workpiece from the measurement light reflected back from the workpiece on the basis of different polarization states. In this case, the exit face of the measurement signal and the detection area of the useful signal do not coincide directly. Therefore, the detection area of the detector unit can easily be made larger than the exit face of the measurement light. The sensor unit can therefore be easily adjusted to optical cables with different diameters.

In a development, the separating apparatus is designed as a double-clad fiber coupler which has a double-clad fiber with a core for guiding the measurement light emitted by the measurement light source, which is preferably designed as a single-mode fiber, and a ring for guiding the measurement light reflected by the workpiece, which is preferably designed as a multi-mode fiber.

In this embodiment, the beam guidance in the sensor unit is entirely or partially fiber-guided. In this case, the exit for the measurement light and the entry for the measurement light reflected back from the workpiece is formed by a double-clad fiber, or more precisely by one fiber end of the double-clad fiber. The measurement light is guided to the workpiece in the core of the double-clad fiber, while the measurement light reflected back from the workpiece is guided in the light-guiding ring. The double-clad fiber forms part of a double-clad fiber coupler or the coupler adjoins the double-clad fiber. The double-clad fiber coupler is used to separate the single-mode measurement light, which is guided in the core of the double-clad fiber, from the multi-mode useful light, which is guided in the ring of the double-clad fiber. For this purpose, the double-clad fiber can be guided in a coupling section of the double-clad fiber coupler adjoining a further fiber, into the core of which part of the useful radiation from the ring of the double-clad fiber is coupled. The further fiber is typically not a double-clad fiber.

The advantage of using a double-clad fiber in the sensor unit is that the diameter of the useful signal entry face (such as 105 μm) can be selected to be larger than the diameter of the measurement light exit face (such as 9 μm) and thus (taking into account the limiting angles of the core and ring of the double-clad fiber as well as the optical cable) can be used with different core diameters of optical cables with optimal coupling efficiency in both directions (sensor system-optical cable for the measurement light and optical cable-sensor system for the useful light). In the event that the beam guiding apparatus has an optical cable for guiding the measurement light, this can also be designed as a double-clad fiber.

In an embodiment, the measurement light source has a first light source, in particular a first laser source, for emitting measurement light at a first measurement wavelength and a second light source, in particular a second laser source, for emitting measurement light at a second measurement wavelength.

In the simplest case, the measurement light source is designed to use two laser sources, for example two laser diodes, to generate measurement light with two narrow-band spectra that are concentrated around the first and second measurement wavelengths respectively. The foci of the measurement light at the two measurement wavelengths are displaced relative to one another along the optical axis of the processing optics of the processing head due to chromatic aberration. The focal position of the processing laser beam can be determined from the ratio of the intensities of the measurement light detected by the detector unit at the first measurement wavelength and at the second measurement wavelength. The individual measurement wavelengths must be selected such that the chromatic confocal response (the measurement light reflected by the workpiece and returned to the laser device and detectable) from at least two light sources overlaps. In the case of a fiber-guided setup, the discrete spectra of the measurement light from the individual light sources can be combined using a WDM (wavelength division multiplexer), circulators or fiber couplers. In the case of a free beam setup, the measurement light of the two measurement wavelengths can be combined using dichroic mirrors or polarization-dependent beam splitters, for example.

Alternatively, the first light source and the second light source can be designed not as laser sources with narrow-band spectra, but as light sources with comparatively broadband spectra around the respective measurement wavelength in order to increase the measurement range at the expense of resolution. In this case, the light sources can be designed as superluminescent diodes, for example.

It is provided for the measurement light source to have at least one pair of light sources in the form of laser sources with a narrow-band spectrum and at least one pair of light sources with a comparatively broadband spectrum in order to open up at least two measurement ranges (fine measurement range and coarse measurement range) with one and the same processing optics.

In a development, the first and/or the second measurement wavelength deviate from a processing laser wavelength of the processing laser beam. In the simplest case, the first measurement wavelength of the first light source is below and the second measurement wavelength of the second light source is above the processing laser wavelength of the processing laser beam, the focal position of which is to be detected. However, this does not necessarily have to be the case. Rather, the first measurement wavelength and the second measurement wavelength can also both be below or above the processing wavelength of the processing laser beam, for example if the focal position is to be determined for a permanently defocused processing.

In order to extend the measurement range along the optical axis of the processing optics, the two light sources of the measurement light source can be supplemented by further light sources, in particular by further pairs of light sources, for example in the form of laser sources or light sources with a comparatively broadband spectrum, the measurement wavelengths of which move further away from the processing laser beam with each additional light source. With the help of a control device of the sensor device, either all light sources of the measurement light source, a selection of certain light sources or only one light source at a time are activated one after the other in a timing-controlled pattern, wherein the intensity of the measurement light emitted by the respective light source and reflected back at the workpiece is captured.

In a development, the measurement light source has a further light source, for example a laser source, which is designed to emit measurement light with a measurement wavelength that corresponds to the processing laser wavelength of the processing laser beam. Such a light source can be used to test or calibrate the sensor unit.

In an embodiment, the measurement light source is designed as a broadband light source or as a tunable light source. In the first case, the measurement light is generated by a broadband light source with a continuous spectrum, such as by means of a superluminescent diode or a supercontinuum laser, to increase the measurement range. In the second case, a tunable source (such as a tunable VCSEL laser diode, a broadband light source with a downstream tunable bandpass filter, etc.) is used as the measurement light source.

It is provided that the device or the sensor unit can have a mode mixer for the measurement light emitted by the measurement light source. In this case, the measurement light is fiber-guided in the sensor unit. The measurement light is first guided in a single-mode fiber and homogenized with the help of the mode mixer and an adjoining multi-mode exit fiber with the smallest possible core diameter (such as 50 μm). In this way, after decoupling from the sensor unit, a uniform intensity distribution can be generated in an adjoining optical cable of the beam guiding apparatus, which is often designed as a multi-mode fiber.

In an embodiment, the device comprises at least two optical elements having a chromatic aberration with different Abbe numbers. The Abbe number of a respective optical element, which is a measure of the dispersion of the respective optical element, can be determined, for example, by selecting the (glass) material of the optical element. The two or more optical elements with the different Abbe numbers can be arranged in the processing optics of the processing head or elsewhere in the beam path of the measurement light.

The optical elements with the different Abbe numbers can be used for different purposes. For example, the two or more optical elements or their Abbe numbers can be designed in such a way that the focal plane of a light source with a narrow-band spectrum, typically in the form of a laser source, the measurement wavelength of which deviates from the processing laser wavelength, is placed on the focal plane of the processing laser beam or coincides with the focal plane of the processing laser beam. In this case, the chromatic aberration affects the measurement light of the light source as if the measurement wavelength were the same as the processing wavelength of the processing laser beam. Alternatively, the measurement range and resolution can be influenced in a targeted manner by the different dispersion or the different Abbe numbers for predetermined measurement light sources. For example, two measurement light sources, the measurement wavelengths of which are spectrally far apart and therefore exhibit a large difference in the axial focal position, can be placed closer together or further apart, which also influences the measurement range and the measurement resolution.

In scanning applications, so-called lateral chromatic aberrations can occur due to chromatic aberration. In the case of a classic F-theta lens with optical elements made of quartz glass, for example, these can lead to the processing laser beam and the measurement light not coinciding exactly and thus to the measurement position on the surface deviating from the processing position of the processing laser beam on the surface. The signal levels are also influenced by this. This effect can be reduced or avoided by using an achromatic lens that has at least two optical elements with different Abbe numbers. With a classic non-achromatic lens, the lateral chromatic aberration can also be corrected by adjusting the scan deflection to the wavelength, but this requires a temporal separation between determining the focal position and the laser processing.

The type of detector device used in the device is adapted to the type of measurement light source used.

In an embodiment, the detector unit is designed as a spectrometer. A detector unit in the form of a spectrometer is typically used if the measurement light source is a broadband light source.

If the overall design of the sensor unit is able to provide a chromatic confocal response that also includes the processing laser wavelength (coupling and decoupling of the measurement light into and from the beam path of the processing laser beam via the coupling device in the form of the beam switch, but not via a beam splitter, such as in the form of a dichroic mirror), the focal position can be ascertained directly from the maximum value of the spectrum of the confocal response when using broadband measurement light or a finely tunable measurement light source (such as with a step width of 2 nm).

If the spectrum of the confocal response does not include the processing laser wavelength, the focal position can supplementally be derived from the ratio of at least two measurement wavelengths, wherein the first measurement wavelength is above and the second measurement wavelength is below the processing laser wavelength. It is useful in this regard to use two maxima from the spectrum of the confocal response. In this case, the focal position can also be derived from the partial or complete course of the spectral response captured by the detector unit.

In the event that the measurement light source has individually switchable light sources with different, discrete measurement wavelengths (such as laser diodes) or is designed as a tunable measurement light source, a simple photodiode or a highly sensitive single photon avalanche diode (SPAD) of an Si or InGaAs variant can be used as the detector unit in order to selectively (for each set measurement wavelength) record the chromatic confocal response of the sensor unit.

In an embodiment, the measurement light source is designed for pulsed emission of the measurement light and the detector unit and the evaluation unit are preferably designed to differentiate between measurement light reflected back from the surface of the workpiece and measurement light reflected back from other locations. The measurement light source, in particular light sources of the measurement light source that have a substantially discrete spectrum, can be designed as pulsed light sources (pulse lengths, for example, in the range of ps to ns). For the differentiation described above, it is expedient if the detector unit is designed as a single photon avalanche diode. In this case, the evaluation apparatus can be designed for chronologically high-resolution dToF (direct time of flight) evaluation by a multi-hit TDC (time-to-digital converter) or by a high-speed ADC (analog-to-digital converter) (such as with 10 GS/s). This allows, for example, the separation of reflection points occurring at different locations in the beam path of the processing laser beam, as described above, and makes it possible to improve the discrimination between the useful signal coming from the workpiece and interfering reflections, comparable to the measurement principle in an OTDR (optical time-domain reflectometer).

Further advantages of the present disclosure are evident from the description and the drawing. Likewise, the features mentioned above and those yet to be presented can be used in each case alone or jointly in any desired combination. The embodiments shown and described should not be understood as an exhaustive list, but rather are of exemplary in character.

In the following description of the drawings, identical reference signs are used for identical or functionally identical components.

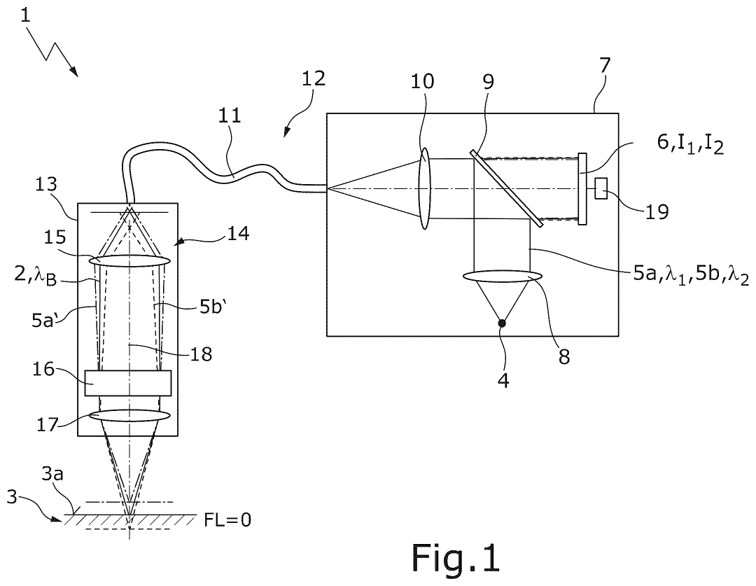

FIG. 1 shows the basic structure of a device 1 for determining the focal position FL of a processing laser beam 2 in relation to a surface 3a of a workpiece 3 to be processed on the basis of a chromatic confocal measurement. The device 1 comprises a measurement light source 4, which is designed to emit measurement light 5a, 5b at two different measurement wavelengths λ₁, λ₂. The measurement light source 4 is arranged together with a detector unit 6 in a housing of a laser device 7, which is also used for providing the processing laser beam 2. The measurement light 5a, 5b emitted by the measurement light source 4 is collimated by a collimation lens 8, impinges on a separating apparatus 9 in the form of a 50:50 beam splitter and is deflected by this in the direction of a focusing lens 10.

The measurement light 5a, 5b is coupled into the beam path of the processing laser beam 2 by means of a coupling device. The measurement light 5a, 5b is coupled together with the processing laser beam 2 into an optical cable 11, which serves as a beam guiding apparatus 12 for guiding the measurement light 5a, 5b to a processing head 13. The processing head 13 has processing optics 14, which in the example shown have collimation optics 15, scanner optics 16 for two-dimensional beam deflection and a focusing optical unit 17. In the example shown, the collimation optics 15 are designed as a collimation lens and the focusing optical unit 17 is designed as a focusing lens, each of which has a chromatic aberration.

The processing laser beam 2 and the measurement light 5a, 5b are focused onto the surface 3a of the workpiece 3 by the processing optics 14, more precisely by the focusing optical unit 17. In the example shown, the focus of the processing laser beam 2 is located exactly at the surface 3a of the workpiece 3, i.e., the focal position FL of the processing laser beam 2, which denotes the distance of the focus of the processing laser beam 2 from the surface 3a of the workpiece 3 along the optical axis 18 of the processing optics 14, is FL=0. Due to the chromatic aberration of the optics 15, 17 of the processing optics 14, the foci of the measurement light 5a, 5b focused on the surface 3a of the workpiece 2 are located above or below the surface 3a of the workpiece 3. The measurement light 5a′, 5b′ reflected by the surface 3a of the workpiece 3, which is shown with dotted or dashed lines in FIG. 1, passes through the processing optics 14 in the opposite direction and is focused behind or in front of an entry face of the optical cable 11. The optical cable 11 or its entry-side end therefore acts as an entry aperture or spatial filter and mainly allows measurement light 5a, 5b or reflected light from the processing laser beam 2 to pass through, the focus of which is on the surface 3a of the workpiece 3.

The measurement light 5a′, 5b′ reflected back, or more precisely a component of the measurement light 5a′, 5b′ reflected back, passes through the optical cable 11 of the beam guiding apparatus 12 in the direction of the laser device 7, enters the laser device 7 and is transmitted from the 50:50 beam splitter 9 to the detector unit 6. The detector unit 6 is designed for capturing the intensity I₁, I₂ of the reflected measurement light 5a′, 5b′ at the first measurement wavelength λ₁ and at the second measurement wavelength λ₂. An evaluation apparatus 19 integrated in the laser device 7 is used for determining the focal position FL of the processing laser beam 2 on the basis of the intensities I₁, I₂ captured by the detector unit 6.

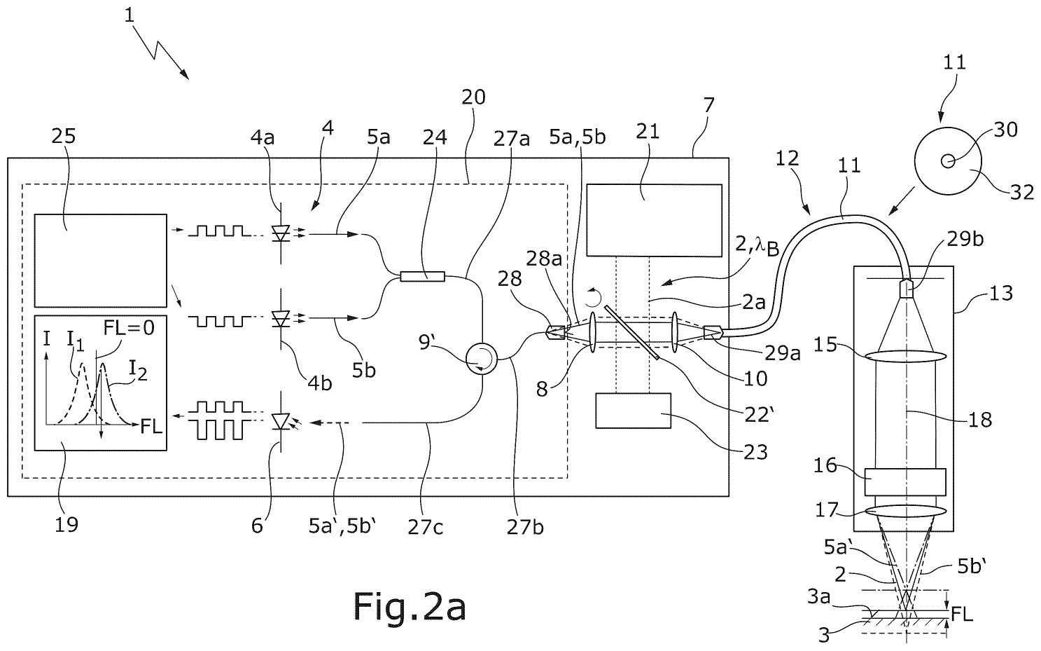

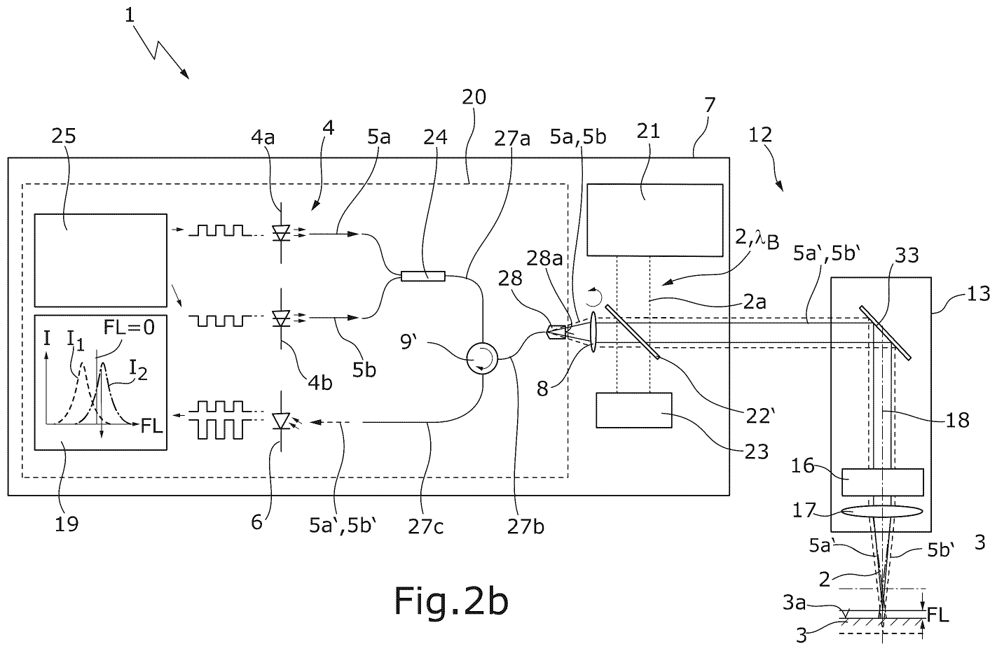

FIG. 2a shows an example of a device 1 that differs from the device 1 shown in FIG. 1 in that, among other things, the measurement light 5a, 5b is fiber-guided in a sensor unit 20 arranged in the laser device 7. The laser device 7 furthermore has a processing laser source 21 designed to emit the processing laser beam 2. In the example shown, the processing laser source 21 is a solid-state laser source designed to emit a processing laser beam 2 with a processing wavelength λ_{B} of 1030 nm. It is understood that the processing laser beam 2 can also have a different processing wavelength λ_{B}, for example 515 nm. The measurement wavelengths λ₁, λ₂ are adjusted to the processing wavelength λ_{B}.

The processing laser beam 2 impinges on a coupling device 22′, which in the example shown is designed as a beam switch, which can be arranged in the beam path 2a of the processing laser beam 2 for processing the workpiece 3 and can be removed from the beam path 2a of the processing laser beam 2 for determining the focal position FL of the processing laser beam 2. For this purpose, the coupling device 22′, which is designed as a deflection mirror in the example shown, can be automatically pivoted from the first position shown in FIG. 2a, in which it is arranged in the beam path 2a of the processing laser beam 2, into a second position located next to the beam path 2a of the processing laser beam 2, as indicated by an arrow. It is understood that the movement of the coupling device 22′ in the form of the beam switch for the selective coupling of the processing laser beam 2 or the measurement light 5a, 5b into the beam guiding apparatus 12 can also be achieved in other ways. In the example shown in FIG. 2a, a beam trap 23 is arranged in the laser device 7 to prevent damage to the laser device 7 by the processing laser beam 2 that may emerge unintentionally from the processing laser source 21.

In the example shown in FIG. 2a, the sensor unit 20 is designed to optionally emit a pilot laser beam in place of the measurement light 5a, 5b, which is coupled into the beam guiding apparatus 12 in place of the measurement light 5a, 5b when the beam switch 22′ is in the second position. The pilot laser beam has a wavelength in the visible wavelength range.

In the example shown in FIG. 2a, the measurement light source 4 has a first laser source 4a in the form of a first laser diode, which is designed to emit measurement light 5a at a first measurement wavelength λ₁ of 980 nm. The measurement light source 4 also has a second laser source 4b in the form of a second laser diode, which is designed to emit measurement light 5b at a second measurement wavelength λ₂ of 1064 nm. The first measurement wavelength λ₁ is smaller and the second measurement wavelength λ₂ is greater than the processing laser wavelength λ_{B} of the processing laser beam 2. This is favorable for determining the focal position FL, as described in more detail below.

The measurement light source 4 can have further light sources in order to improve the accuracy of the determination of the focal position FL or to increase the measurement range. It is also provided for the measurement light source to have a light source in the form of a further laser source, the measurement wavelength of which corresponds to the processing laser wavelength λ_{B} of the processing laser beam 2. The further laser source can be used, for example, to calibrate the sensor unit 20.

The additional or alternative use of (pairs of) light sources that have a slightly broader spectral range than the light sources in the form of the laser sources 4a, 4b is also provided in order to increase the measurement range at the expense of the resolution. In particular, the pair of laser sources 4a, 4b shown in FIG. 2a can be supplemented by a further pair of light sources with a slightly more broadband spectral range in order to open up two measurement ranges (fine measurement range and coarse measurement range).

It is also provided that at least two optical elements, for example the collimation optics 15 and the focusing optical unit 17 of the processing head 13, have a chromatic aberration with different Abbe numbers and are designed in such a way that the focal plane of a light source 4a, 4b, . . . with a narrow-band spectrum, typically in the form of a laser source, the measurement wavelength λ₁, λ₂, . . . of which deviates from the processing laser beam wavelength λ_{B}, is placed on the focal plane of the processing laser beam 2 and coincides with the focal position FL of the processing laser beam 2.

The measurement light 5a, 5b with the two measurement wavelengths λ₁, λ₂ is combined in FIG. 2a with the help of a wavelength combiner 24 in the form of a wavelength multiplexer. The combined measurement light 5a, 5b passes through a first fiber 27a, which couples the combined measurement light 5a, 5b at a first port into a separating apparatus in the form of a fiber circulator 9′ . The measurement light 5a, 5b is decoupled from the sensor unit 20 via a second fiber 27b at a second port of the fiber circulator 9′. The second fiber 27b has an exit-side end with an end cap 28, the end face 28a of which forms the exit face for the measurement light 5a, 5b and the entry face for the useful signal in the form of the measurement light 5a, 5b reflected back from the surface 3a of the workpiece 3. A third port of the fiber circulator 9′ is connected to a third fiber 27c, which supplies the useful signal in the form of the measurement light 5a′, 5b′ reflected back to the detector unit 6, which in the example shown is designed in the form of a silicon photodiode. The fiber circulator 9′ serves as a separating apparatus for separating the measurement light 5a, 5b emitted by the measurement light source 4 from the measurement light 5a′, 5b′ reflected back from the surface 3a of the workpiece 3.

Since, in the example shown in FIG. 2a, the exit and entry faces of the measurement light or the useful signal coincide directly at the end face 28a of the end cap 28, the sensor unit 20 is sensitive to back-reflected measurement light, which primarily occurs when the measurement light emerges from the end cap 28 of the second fiber 27b (transition from glass to air). In the example shown, this is countered by providing the end cap 28 of the second fiber 27b, which serves as the exit or entry fiber, with an anti-reflective coating, which is applied to the end face 28a of the end cap 28 in order to suppress the reflection of the emerging measurement light 5a, 5b during the transition from glass to air. The optical cable 11, which serves as the beam guiding apparatus 12, also has a first end cap 29a for entry of the measurement light 5a, 5b into the laser device 7 and a second end cap 29b for emergence of the measurement light 5a, 5b into the processing head 13. The two end caps 29a, 29b can also have an anti-reflective coating in order to suppress unwanted back reflections of the processing laser beam 2, the measurement light 5a, 5b or the measurement light 5a′, 5b′ reflected back.

The measurement light 5a, 5b is guided in a core 30 of the optical cable 11, which is surrounded by a sheath 32 made of glass, in which no light conduction is to take place (cf. the cross-section of the optical cable 11 shown in FIG. 2a). In the event that the optical cable 11 is designed in the form of a hollow-core fiber, the measurement light 5a, 5b is guided in the hollow core 30 of the optical cable 11. In this case, the provision of anti-reflective coatings or end caps on the optical cable 11 can generally be dispensed with.

It is provided that the measurement light 5a, 5b is first guided in a single-mode fiber and mixed in a mode mixer, which can be arranged, for example, after the wavelength combiner 24 before or after the first fiber 27a. After the mode mixer, the measurement light 5a, 5b is homogenized in a subsequent multi-mode fiber with the smallest possible core diameter (such as 50 μm), which can be the third fiber 27c, for example. In this way, after decoupling the measurement light 5a, 5b from the sensor unit 20, a uniform intensity distribution can be generated in the optical cable 11 of the beam guiding apparatus 12, which in this case is designed as a multi-mode fiber.

As can also be seen in FIG. 2a, the laser device 7 also has a control device 25, which is used to control the measurement light source 4, or more precisely the two laser sources 4a, 4b. The two laser sources 4a, 4b are controlled sequentially or in push-pull mode by means of the control device 25. In this way, the intensity I₁, I₂ of the measurement light 5a, 5b reflected back from one of the two laser sources 4a, 4b can be detected by the evaluation apparatus 19 in a respective time interval of the clocked control. FIG. 2a shows the course of the intensities I₁, I₂ on the basis of the focal position FL. As can be seen in FIG. 2a, the ratio I₁/I₂ between the two intensities I₁, I₂ depends on the focal position FL, which is why the evaluation apparatus 19 can be used to determine the focal position FL on the basis of this ratio. The evaluation apparatus 19 can be designed in the form of suitable hardware and/or software.

In the example shown, only the reflected measurement light 5a′, 5b′ guided in the core 30 of the optical cable 11 is detected by the detector unit 6, while the reflected measurement light guided in the sheath 32 or the useful light component guided in the sheath 32 is suppressed with the aid of etched sheath surfaces of the optical cable 11 or by other measures. In the event that the optical cable 11 has a light-guiding ring (see below), a further entry aperture can be provided in the sensor device 20 in order to suppress the measurement light 5a′, 5b′ reflected back and guided in the ring.

FIG. 2b shows a device 1 which differs from the device 1 shown in FIG. 2a in that the beam guiding apparatus 12 is designed to guide the processing laser beam 2 and the measurement light 5a, 5b in free beam propagation. In this case, an end of the second fiber 27b facing away from the fiber circulator 9′ forms the entry and exit aperture of the sensor unit 20.

The processing head 13 has a deflection mirror 33 for deflecting the processing laser beam 2 and the measurement light 5a, 5b.

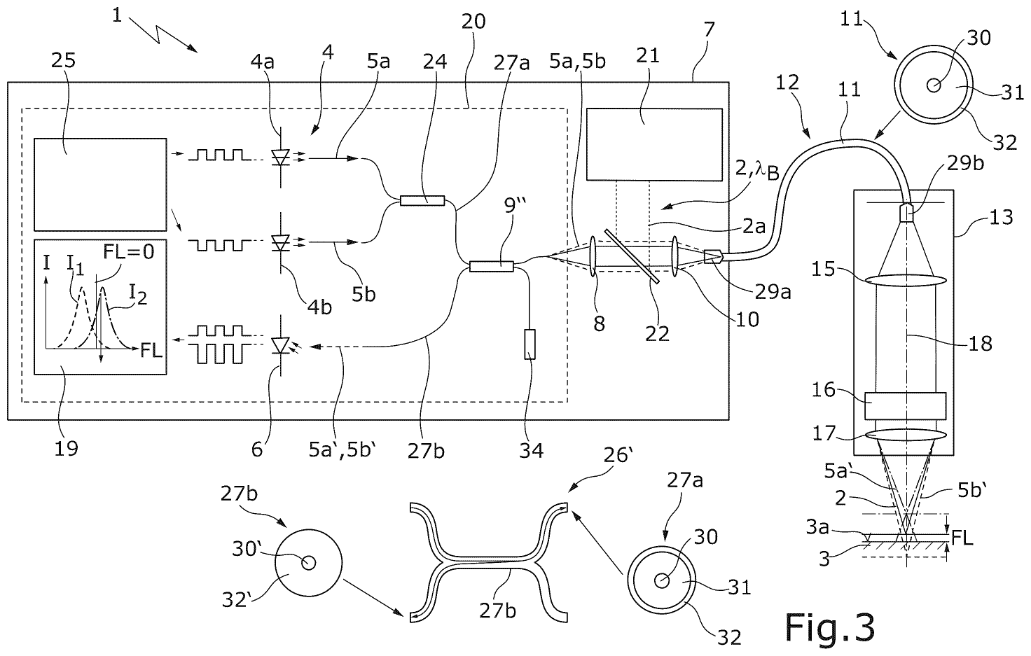

FIG. 3 shows a device 1 that differs substantially from the device 1 shown in FIG. 2a with respect to the design of the separating apparatus, which is not designed as a fiber circulator 9′ but as a double-clad fiber coupler 9′. The double-clad fiber coupler 9′ is shown in detail at the bottom of FIG. 3. The double-clad fiber coupler 9′ comprises a double-clad fiber 27a having a core 30 for guiding the measurement light 5a, 5b emitted from the measurement light source 4 and combined in the wavelength combiner 24. The core 30 of the double-clad fiber 27a is designed as a single-mode fiber. The double-clad fiber 27a also has a ring 31 for guiding the measurement light 5a′, 5b′ reflected by the workpiece 3, which is designed as a multi-mode fiber and which is surrounded by a sheath 32. In the device 1 shown in FIG. 3, the beam guiding apparatus 12 has an optical cable 11 in the form of a double-clad fiber, in the core 30 of which the measurement light 5a, 5b is guided and in the ring 31 of which the measurement light 5a′, 5b′ reflected back from the surface 3a of the workpiece 3 is guided to the laser device 7.

The double-clad fiber coupler 9′ is used to separate the single-mode measurement light, which is guided in the core 30 of the double-clad fiber 27a, from the multi-mode useful light, which is guided in the ring of the double-clad fiber 27a. For this purpose, in the double-clad fiber coupler 9′ , the double-clad fiber 27a is guided in a coupling section parallel to and adjoining a further fiber 27b, which has a core 30′ surrounded by a sheath 32′ (without a light-guiding ring). A part of the useful radiation from the ring 31 of the double-clad fiber 27a is coupled into the core 30′ of the further fiber 27b in the coupling section and supplied to the detector unit 6 at a first end of the further fiber 27b. A beam trap 34 is attached to a second end of the further fiber 27b in order to absorb measurement light 5a, 5b coupled over from the double-clad fiber 27a into the further fiber 27b. In this case, the detector unit 6 serves to detect the measurement light 5a′, 5b′ reflected back, which is guided in the ring 31 of the optical cable 11 of the beam guiding apparatus 12, which is designed as a double-clad fiber.

It is made possible for the detector unit 6 to separately capture the measurement light 5a′, 5b′ guided in the core 30, in the ring 31 and/or in the sheath 32 of the optical cable 11 and reflected back from the surface 3a of the workpiece 3. This allows for a two-stage measuring process in which the evaluation of the useful light coming from the sheath 32 and/or the ring 31 is used for an inaccurate determination of the focal position FL with an enlarged measurement range and the sole evaluation of the useful light component coming from the core 30 of the optical cable 11 is used for determining the focal position FL accurately with a small measurement range. It is also provided to capture only the useful light coming from the sheath 32 and/or the ring 31 of the optical cable 11 without capturing the useful light coming from the core 30 of the optical cable 11 at all.

The device 1 shown in FIG. 3 has a coupling device 22 in the form of a dichroic beam splitter mirror, which is used for coupling the measurement light 5a, 5b of the measurement light source 4 into the beam path 2a of the processing laser beam 2 and for decoupling the measurement light 5a′, 5b′ reflected back from the surface 3a of the workpiece 3 from the beam path 2a of the processing laser beam 2. Instead of the dichroic beam splitter mirror, the coupling device 22 can also be designed in the form of a scraper mirror, an apertured mirror or the like.

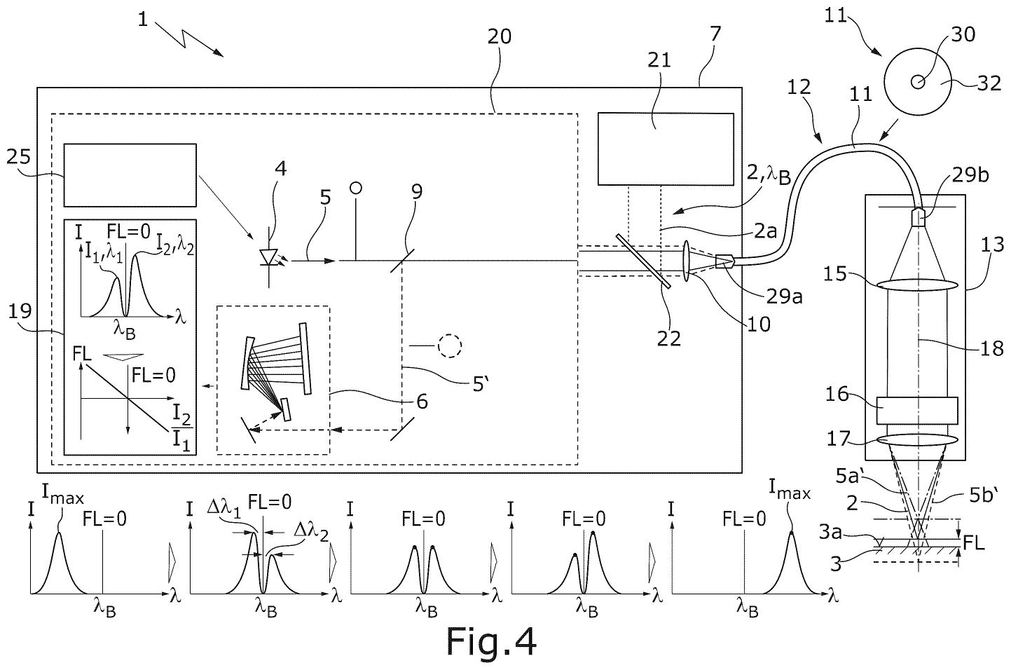

FIG. 4 shows an example of the device 1 that differs substantially from the device 1 shown in FIG. 3 with respect to the design of the sensor unit 20. The sensor unit 20 has a measurement light source 4 in the form of a broadband light source, which is designed as a superluminescent diode in the example shown. The sensor unit 20 is designed to guide measurement light 5 emitted by the measurement light source 4 in free beam propagation. As in FIG. 1, a non-polarizing 50:50 beam splitter serves as separating apparatus 9 for separating the measurement light 5, which propagates in the direction of the workpiece 3, from the measurement light 5′ reflected back at the surface 3a of the workpiece 3. The sensor unit 20 also has a detector unit 6 in the form of a spectrometer.

In the sensor unit 20 shown in FIG. 4, the measurement light 5′ reflected back from the surface 3a of the workpiece 3 has a larger beam diameter than the measurement light 5 emitted by the measurement light source 4. The detector unit 6 is designed for capturing the measurement light 5′ reflected back with the larger beam diameter. By using such a detector unit 6, it is made possible to capture the measurement light 5′ reflected back even with fiber optic cables 11 used in the beam guiding apparatus 12 that differ in the diameter of the core 30. In particular, the useful signal of the entire cross-section of the optical cable 11 can also be made available to the detector unit 6 for evaluation in the case of a beam guiding apparatus 12 with an optical cable 11 that has a core 30 with a large diameter of, for example, 400 μm.

The diagrams shown in FIG. 4 below the illustration of the laser device 7 or the sensor unit 20 show the qualitative course of the spectrum I(λ) of the chromatic confocal response of the measurement light reflected back from the surface 3a of the workpiece 3 at different focal positions FL (from left to right: the workpiece 3 is removed from the processing head 13 starting in front of a focal position FL, which is located inside the workpiece 3, via the focal position FL=0, until the focal position FL of the processing laser beam 2 is located in front of the surface 3a of the workpiece 3. Close to the focal position FL=0 (cf. the middle three diagrams), the exact focal position FL can be ascertained from the partial or entire course of the spectral response or from a ratio of the intensities I₁, I₂ of at least two measurement wavelengths λ₁, λ₂. In the example shown, the two measurement wavelengths λ₁, λ₂ have the same difference wavelength Δλ in relation to the processing laser wavelength λ_{B} of the processing laser beam 2 and these are the measurement wavelengths λ₁, λ₂ at which the spectral response shows a maximum in each case. With the ratio I₂/I₁=1—assuming wavelength-independent transmission or reflection—FL=0 applies for the focal position (cf. the middle one of the five diagrams). Far outside of the focal position FL=0 (cf. the first and fifth diagrams), the maximum Iₘₐₓ of the spectrum can be used to determine the focal position FL.

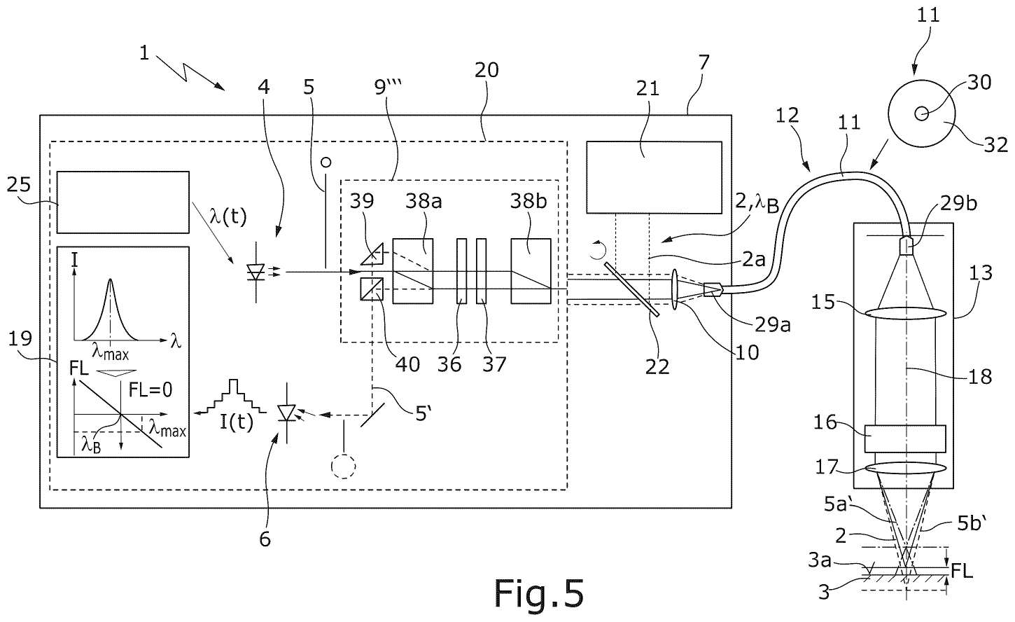

The device 1 shown in FIG. 5 differs from the device 1 shown in FIG. 4 in that, among other things, the measurement light source 4 is tunable and, in the example shown, is designed as a tunable laser source. In addition, the sensor device 20 has a separating apparatus 9″ , which is designed as a free beam circulator. The free beam circulator 9″ comprises a Faraday rotator 36, a λ/2 plate 37, two birefringent crystals 38a, b as well as a deflecting prism 39 and a polarization beam splitter 40.

For determining the focal position FL in the device 1 shown in FIG. 5, the measurement wavelength λ of the measurement light source 4 is tuned stepwise, such as in steps of 2 nm. With the help of a detector unit 6, which is designed as a silicon photodiode, a time-dependent intensity curve I(t) of the measurement light 5′ reflected back is recorded, to which a wavelength-dependent intensity distribution I(λ) corresponds. In the evaluation apparatus 19, the maximum wavelength λₘₐₓ is determined at which the wavelength-dependent intensity distribution I(λ) is at its maximum. The focal position FL of the processing laser beam 2 can be determined on the basis of the maximum wavelength λₘₐₓ or on the basis of the distance of the maximum wavelength λₘₐₓ from the processing laser wavelength λ_{B}.

In the device 1 described further above, the measurement light source 4 can be designed to emit pulsed measurement light 5a, 5b, 5 with pulse lengths, for example, in the range of ps to ns. In this case, the detector unit 6 can be designed as a single photon avalanche diode, for example of an Si or InGaAs variant. The evaluation apparatus 19 can be designed for chronologically high-resolution dToF (direct time of flight) evaluation, for example by a multi-hit TDC (time-to-digital converter) or by a high-speed ADC (such as with 10 GS/s). This allows, for example, the separation of reflection points occurring at different locations in the beam path 2a of the processing laser beam 2 and makes it possible to improve the discrimination between the useful signal coming from the workpiece 3 and interfering reflections.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for determining a focal position of a processing laser beam in relation to a surface of a workpiece, comprising:
a measurement light source configured to emit measurement light at at least two different measurement wavelengths;
a processing head configured to focus the measurement light onto the workpiece;
a beam guide configured to guide the measurement light to the processing head;
at least one optical element with chromatic aberration, which is passed through by the measurement light and is arranged in the processing head;
a detector configured to capture an intensity of the measurement light reflected back by the surface of the workpiece; and
an evaluator configured to determine the focal position of the processing laser beam in relation to the surface of the workpiece using the intensity captured by the detector,
wherein the beam guide is configured for jointly beam-guiding the processing laser beam and the measurement light to the processing head.

2. The device according to claim 1, in which the measurement light source is integrated in a laser device configured to provide the processing laser beam, which preferably has a processing laser source configured to emit the processing laser beam, and in which the beam guide is configured for jointly beam-guiding the processing laser beam and the measurement light from the laser device to the processing head.

3. The device according to claim 1, in which the beam guide has an optical cable configured for jointly beam-guiding the processing laser beam and the measurement light to the processing head.

4. The device according to claim 3, wherein the optical cable is configured as a hollow-core fiber or as a multi-clad fiber.

5. The device according to claim 3, in which the detector is configured for separately capturing the intensity of the measurement light reflected back from the surface of the workpiece in a core, in a sheath and/or in a ring of the optical cable.

6. The device according to claim 1, in which the beam guide is configured for jointly beam-guiding the processing laser beam and the measurement light in free beam propagation.

7. The device according to claim 1, further comprising:
a coupling configured to couple the measurement light of the measurement light source into the beam path of the processing laser beam and configured to decouple the measurement light reflected back from the surface of the workpiece from the beam path of the processing laser beam.

8. The device according to claim 1, further comprising:
a coupling in a form of a beam switch, which is configured to be arranged in the beam path of the processing laser beam for selective coupling of the processing laser beam or the measurement light into the beam guide and can be removed from the beam path of the processing laser beam.

9. The device according to claim 1, further comprising:
a separator configured to separate the measurement light emitted by the measurement light source from the measurement light reflected back from the surface of the workpiece.

10. The device according to claim 9, in which the separator is configured as a circulator in a form of a fiber circulator or a free beam circulator.

11. The device according to claim 9, in which the separator is configured as a double-clad fiber coupler which has a double-clad fiber with a core configured to guide the measurement light emitted by the measurement light source and a ring configured to guide the measurement light reflected back from the surface of the workpiece.

12. The device according to claim 1, in which the measurement light source has a first light source configured to emit measurement light at a first measurement wavelength and a second light source configured to emit measurement light at a second measurement wavelength.

13. The device according to claim 12, in which the first and/or the second measurement wavelengths deviate from a processing laser wavelength of the processing laser beam.

14. The device according to claim 13, wherein the measurement light source has a further light source, wherein the measurement wavelength of the further light source corresponds to the processing laser wavelength.

15. The device according to claim 1, wherein the measurement light source is configured as a broadband light source or as a tunable light source.

16. The device according to claim 1, comprising at least two optical elements having a chromatic aberration with different Abbe numbers.

17. The device according to claim 1, wherein the detector is configured as a spectrometer.

18. The device according to claim 1, wherein the measurement light source is configured for pulsed emission of the measurement light, wherein the detector and the evaluator are configured to differentiate between measurement light reflected back from the surface of the workpiece and measurement light reflected back from other locations.
